(19) United States
(12) Patent Application Publication
(10) Pub. No.: US 2002/0123817 A1
(43) Pub. Date: Sep. 5, 2002

(54) Method and apparatus for preparing an anatomical implant

(76) Inventors: Bernhard Clasbrummel, Bochum (DE); Axel Hebecker, Spardorf (DE); Joachim Hey, Nuernberg (DE)

Correspondence Address: SCHIFF HARDIN & WAITE, 6600 SEARS TOWER, 233 S WACKER DR, CHICAGO, IL, 60606-6473, US

(21) Appl. No.: 10/036,618

(22) Filed: Dec. 21, 2001

(30) Foreign Application Priority Data
Dec. 21, 2000 (DE) 10064111.3

(51) Int. Cl. G06F 19/00

(52) U.S. Cl. 700/118; 700/117

(57) ABSTRACT

In a method and an apparatus for preparing an anatomical implant, a movable C-arm X-ray apparatus is used to acquire a dataset from body tissue of a subject exhibiting a fault, and an implant for introduction into the body of the life form is intra-operatively prepared on the basis of the 3D dataset.

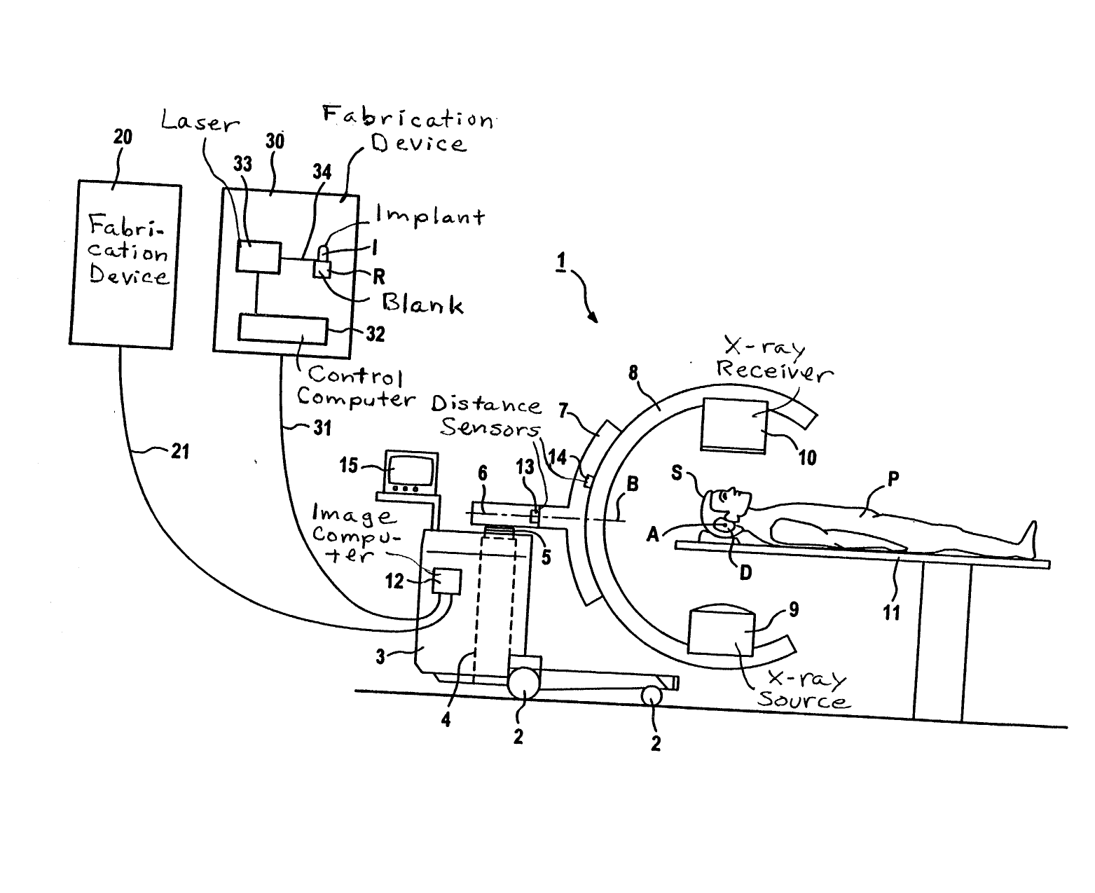

### BACKGROUND OF THE INVENTION

1. Field of the Invention

The invention is directed to a method and to an apparatus for preparing an anatomical implant.

2. Description of the Prior Art

As a consequence of accidents or sicknesses, it occurs in medicine that body tissue, particularly bone tissue or bone structures, having an irreparable fault, for example parts of the calvarium are missing, must be replaced by artificial elements, referred to as implants, that are composed of physically compatible substances and that are simulated in shape to the natural body tissue that they replace.

In order to be able to manufacture such an implant for a living subject, it is currently standard to use a first operation to measure, for example, a bone structure that is to be replaced by an implant, or that is to be supplemented with an implant. Subsequently, the implant is individually prepared for the respective subject based on the measured values and is introduced in the subject in a second operation. Under certain circumstances, there is also the possibility of utilizing a prefabricated implant during an operation on a subject for simple, relatively uncomplicated implants.

As a rule, however, two operations are needed in order to supply a subject with an implant, for which reason the financial cost for such a medical procedure is relatively high.

U.S. Pat. No. 5,741,215 discloses a method with which three-dimensional models, including implants, can be produced by a stereo-lithography technique based on image data acquired with an x-ray computed tomography system.

U.S. Pat. No. 5,768,134 discloses a method for manufacturing a medical model, for example, a prosthesis, based on digital image data. By designational variation of the image data, a prostheses can be produced that has an additional feature that has a useful function for the medical use of the prosthesis. The prosthesis can be manufactured by rapid prototyping.

German OS 44 21 153 discloses a method for manufacturing a prosthesis replacing a bone structure of a patient, wherein the implantable prosthesis is fabricated from a prosthesis blank in material removing fashion by individual adaptation to the anatomical features of the bone structure prepared to receive the implantation.

U.S. Pat. No. 4,575,805 discloses a method and a dental apparatus for manufacturing an implant. For example, an opening in a tooth of a patient is measured with optical means, whereby a set of image data describing the opening is acquired. By milling, for example, an implant that fits into the opening can be manufactured on the basis of the set of image data.

German OS 199 03 122 discloses a method for manufacturing true-to-life, three-dimensional models or sculptures of living subjects or sculptural subjects from the past. The subject contour is sampled with high precision and digitized. Subsequently, a 3D model is generated in the computer from the contoured data, with a rapid prototyping system with which the three-dimensional models are manufactured being controlled on the basis of a model data.

German OS 197 38 342 discloses a method and a computed tomography apparatus for scanning a subject during an interventional procedure, for example a biopsy.

German OS 195 12 819 discloses a C-arm x-ray apparatus with which a three-dimensional image of a body region of a patient can be acquired.

### SUMMARY OF THE INVENTION

An object of the present invention is to provide a method and an apparatus of the type initially described which allows the financial outlay for providing a subject with an implant to be reduced.

This object is inventively achieved by a method wherein a 3D dataset of a body tissue of the life form exhibiting a fault is first produced, the preparation of the implant provided for insertion into the body of the subject ensuing with reference thereto. The preparation of the 3D dataset and the preparation of the implant ensue during a single operation, i.e. intra-operatively. Only one operation is required for introducing an implant, as a result the costs for the introduction of an implant into a subject are considerably reduced. Moreover, the complication rate for such medical interventions can be significantly reduced since a second operation, which always involves a risk, can be foregone.

The 3D dataset is produced from a series of 2D projections of the subject registered from different projection directions. To this end, a C-arm x-ray apparatus is employed whose C-arm carries an x-ray source and an x-ray receiver, is moved around the subject for acquisition of the 2D projections. The registration of the 2D projections can ensue during a motorized adjustment of the C-arm around its angulation axis, or during a motorized adjustment of the C-arm along its circumference, i.e. around its orbital axis.

IN an embodiment of the invention the 3D dataset is acquired from a bone structure of the subject. As used herein “bone structures” means osseous and cartilaginous tissue structures of a subject, i.e. joints and tendons as well.

In a preferred embodiment of the invention the implant is produced in automated fashion on the basis of the 3D dataset. As a rule, the production of the implant is configured such that a dataset describing the implant to be fabricated is generated on the basis of the 3D dataset, the dataset describing an implant being transferred to a mechanical fabrication device that produces the implant in automated fashion from a blank based on the dataset describing the implant. Various fabrication methods are suitable for the fabrication of the implant, these also being employable in combination. For example, the implant can be manufactured by lathing, milling, drilling or other material removing manufacturing methods. However, there is also the possibility of manufacturing the implant from a blank by other manufacturing methods, for example with lasers.

### DESCRIPTION OF THE DRAWINGS

The single FIGURE schematically illustrates an inventive apparatus for the intra-operative preparation of an implant.

### DESCRIPTION OF THE PREFERRED EMBODIMENTS

The inventive apparatus shown in the FIGURE has a movable C-arm x-ray apparatus 1. The C-arm x-ray apparatus 1 has an apparatus carriage 3 provided with wheels 2 in which a lifting mechanism 4 that includes a column 5 (schematically indicated in the FIGURE ) is arranged. A holder 6 at which a support device 7 for a C-arm 8 is present is arranged at the column 5. Displaced on the C-arm 8 opposite one another are an x-ray source 9 which emit a cone-shaped x-ray beam, and an x-ray receiver 10.

The C-arm x-ray apparatus 1 shown in the FIGURE allows a 3D dataset of a body part of a patient P borne on a patient support 11 to be prepared. In the exemplary embodiment, an image computer 12 connected to the x-ray receiver 10 (in a way not shown) is arranged in the apparatus carriage 3 for this purpose. In a known way, the image computer 12 can reconstruct a 3D dataset of the body part to be portrayed from a series of 2D projections acquired with the x-ray source 9 and x-ray receiver 10 that are acquired by an adjustment of the C-arm 8 around a body part of the patient P to be presented in an image. The C-arm 8 is motor-adjusted by approximately 190° either along its circumference around the orbital axis A (schematically indicated in the FIGURE) or around the angulation axis B, (also schematically indicated in the FIGURE), whereby approximately 50 through 100 2D projections of the body part of the patient P are acquired during the adjustment. Since the position of the C-arm 8 is identified with the assistance of distance sensors 13, 14 for each of the 2D projections, the projection geometries can be identified for each 2D projection of the series of 2D projections, these projection geometries being required for the reconstruction of a 3D dataset of the body part of the patient P. In the exemplary embodiment shown in the FIGURE, a 3D dataset of the skull S of the patient P, which exhibits a fault D schematically indicated in the FIGURE, has been acquired by adjustment of the C-arm 8 around the angulation axis B. Using known methods, 2D images or 3D images of the skull S of the patient P can be produced from the 3D dataset, these images being displayed on a display device 15 connected to the image computer 12. Moreover, the fault D, whereby is a opening of the skull S, can be measured on the basis of the 3D dataset of the skull S of the patient P, so that the image computer 12 can generate a dataset that has the dimensions and shape of an implant I covering the fault. The measuring is initiated, for example, by a physician, who marks the fault in 2D images or in a 3D image with input unit, for example, a joy stick (not shown), connected to the image computer 12.

Finally, the implant I is intra-operatively produced, so that the measurement of the fault D can occur, the implant I can be produced and, following thereupon, the fault D can be eliminated by introducing the implant I into the skull S of the patient P in one operation. In the exemplary embodiment, two fabrication devices 20, 30 are provided for the intra-operative production of the implant I, these two fabrication devices 20, 30 being connected to the image computer 12 of the C-bend x-ray device 1 via data cables 21, 31. The fabrication device 20 in the case of the present exemplary embodiment is a device with which an implant can be fabricated from a blank by material removing methods such as lathing, milling and drilling. The fabrication device 30, in contrast, is a device with which an implant I can be formed from a blank R with laser beams.

In the present exemplary embodiment, the dataset generated by the image computer 12, this dataset describing the dimensions of the implant I for introduction into the skull S of the patient P, is communicated via the data cable 31 to a control computer 32 of the fabrication device 30. This drives a laser device 33 that produces the implant I from the blank R with laser beam 34 on the basis of the dataset. In a known way, the implant I is thereby composed of a physiologically compatible material.

Finally, the implant I produced on basis of the 3D dataset can be introduced directly into the skull S of the patient P for the elimination of the fault D intra-operatively, i.e. in the same operation.

The above-described, inventive device need not necessarily employ both the fabrication device 20 and the fabrication device 30. Only one of the two fabrication devices need be present.

Moreover, the apparatus can employ one or more other fabrication devices suitable for the intra-operative preparation of an implant and these can also collaborate for manufacturing the implant.

The data transmission from the image computer 12 to the fabrication devices need not ensue by a hardwired connection, but can ensue via infrared signals or radio signals or by data carriers, for example a diskette.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for preparing an anatomical implant, comprising the steps of:
intra-operatively generating a three-dimensional dataset of body tissue of a subject exhibiting a fault to be corrected by an implant from a series of two dimensional projections of the body tissue obtained from respectively different projection directions with a movable C-arm x-ray apparatus, but moving an x-ray source and a radiation receiver on a C-arm around said subject; and
intra-operatively preparing said implant adapted for introduction into said subject from said three-dimensional dataset.

2. A method as claimed in claim 1 comprising acquiring a three-dimensional dataset which represents a bone structure of said subject.

3. A method as claimed in claim 1 comprising intra-operatively preparing said implant with an automated device which is supplied with said three-dimensional dataset.

4. An apparatus for preparing an anatomical implant comprising:
a C-arm x-ray apparatus having a C-arm with an x-ray source and a radiation receiver mounted thereon, said C-arm x-ray apparatus intra-operatively generating a three-dimensional dataset of body tissue of a subject exhibiting a fault, to be corrected with an implant, by obtaining a series of two-dimensional projections of the body tissue from respectively different projection directions by moving said C-arm, with said x-ray source and said radiation detector thereon, around the body tissue; and
an implant-producing device which intra-operatively produces said implant from said three-dimensional dataset.

5. An apparatus as claimed in claim 4 wherein said dataset represents a bone structure, and wherein said implant is adapted to replace said bone structure.

6. An apparatus as claimed in claim 4 wherein said implant-preparing device is an automated device which is supplied with said three-dimensional dataset and automatically prepares said implant therefrom.
